(19) United States
(12) Patent Application Publication
(10) Pub. No.: US 2010/0117829 A1
(43) Pub. Date: May 13, 2010

(54) Method for operating a flow sensor subjected to thermal and/or chemical treatments

(76) Inventors: Felix Mayer, Stafa (CH); Mark Hornung, Mannedorf (CH); Pascal Gerner, Zurich (CH)

Correspondence Address: RICHARD F. JAWORSKI;Cooper & Dunham LLP, 30 Rockefeller Plaza, New York, NY, 10112, US

(21) Appl. No.: 12/587,777

(22) Filed: Oct. 13, 2009

(30) Foreign Application Priority Data
Nov. 12, 2008 (EP) 08019732.0

(51) Int. Cl. G08B 21/00; G06F 9/44; G07C 3/00; G06F 12/00

(52) U.S. Cl. 340/540; 717/168; 377/15; 711/154; 711/E12.001

(57) ABSTRACT

A flow sensor is equipped with a non-volatile memory for storing various information, such as a count of thermal and/or chemical treatments for sterilization that the sensor has been subjected to, a serial number, an expiry date, or notifications. When connecting the flow sensor to a control unit, this data is read out and processed appropriately. For example, after each treatment, the count of thermal treatments stored in memory is increased, or the expiry date is checked against the current date.

### CROSS REFERENCE TO RELATED APPLICATIONS

This application claims the priority of European patent application 08019732.0, filed Nov. 12, 2008, the disclosure of which is incorporated herein by reference in its entirety.

### BACKGROUND OF THE INVENTION

The invention relates to a method for operating a flow sensor, wherein said flow sensor is repetitively subjected to thermal and/or chemical treatment for sterilization and/or cleaning. The invention also relates to a device for measuring flows adapted to carry out this method.

In some applications, flow sensors for gases or liquids have to be subjected to thermal and/or chemical treatments at regular or irregular intervals, in particular for sterilization and/or cleaning. This is particularly true for flow sensors used in medical applications.

During such thermal and/or chemical treatment, the flow sensor is advantageously subjected to temperatures exceeding 100° C., e.g. in order to destroy germs, and/or it is subjected to sterilizing agents.

Treatments of this type can affect the reliability of the sensor. This is in particular true for sensors integrated on semiconductors, such as e.g. described in DE 10129300 or EP 1840535, where the increased temperature or aggressive chemicals may e.g. affect the properties of the integrated electronic components. Hence, such sensors are often disposed after a single use, which leads to high costs. Alternatively, more rugged, but typically less accurate, types of sensors better suited for thermal and/or chemical sterilization treatment have to be employed.

### BRIEF SUMMARY OF THE INVENTION

Hence, it is a general object of the invention to provide a solution allowing to use thermal and/or chemical treatment of the flow sensors that allows accurate measurements while keeping costs low.

In a first aspect, the invention relates to a method for operating an flow sensor, wherein said flow sensor comprises a digital memory, said method comprising the steps of

repetitively subjecting said flow sensor to thermal and/or chemical treatment for sterilization and/or cleaning, and

storing a number indicative of a count of treatments that said flow sensor has been subjected to in non-volatile manner in said memory and updating said number after each treatment of said flow sensor.

In a second aspect, the invention relates to a device for measuring a flow comprising a control unit and a flow sensor, wherein said flow sensor is detachably connectable to said control unit, wherein said flow sensor comprises a non-volatile memory for receiving a number indicative of a count of thermal and/or chemical treatments the flow sensor has been subjected to and wherein said control unit is structured and adapted to cause said number to be updated after a treatment.

In its various aspects, the invention allows to increase measurement quality or reliability e.g. by issuing a warning when the count of treatments exceeds a given limit, and/or the stored number can e.g. be used for quality assurance and failure analysis.

The invention is particularly well suited for flow sensors having a semiconductor substrate with a heater and at least one temperature sensor integrated thereon. In this case, the memory can also be integrated on the semiconductor substrate, which allows to provide a low cost solution.

In an advantageous application, the flow sensor is connected to a control unit when it has to measure a flow. During treatment, the flow sensor is disconnected from the control unit such that there is no need to subject the control unit to the treatment, but merely the flow sensor alone.

The control unit can cause the number in the memory of the flow sensor to be updated after each treatment, either in response to a manual command or automatically.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 is a block diagram of a device for measuring the flow of a fluid and

FIG. 2 is a view of the components of the device.

### DETAILED DESCRIPTION OF THE INVENTION

### The Flow Sensor Device

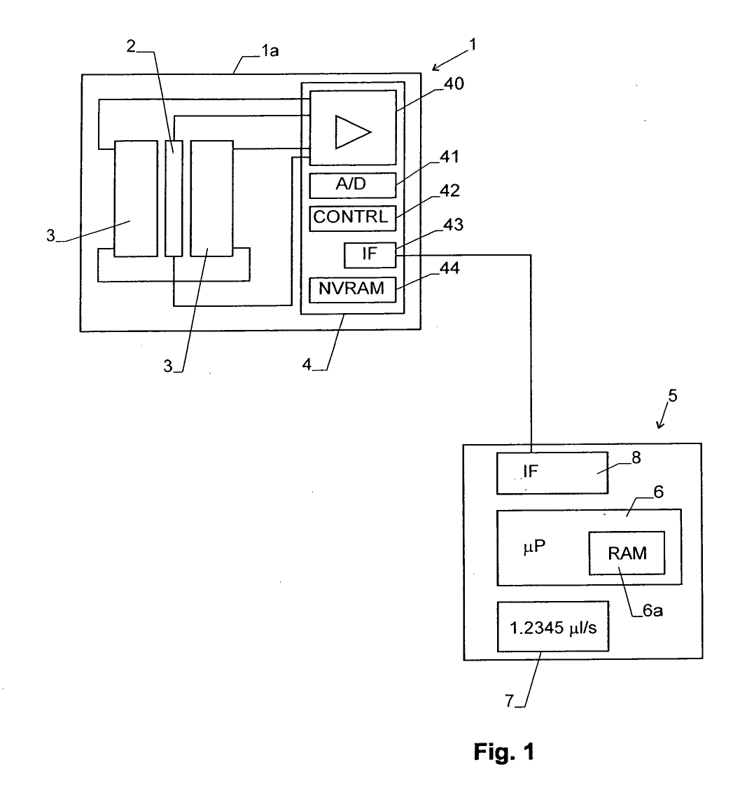

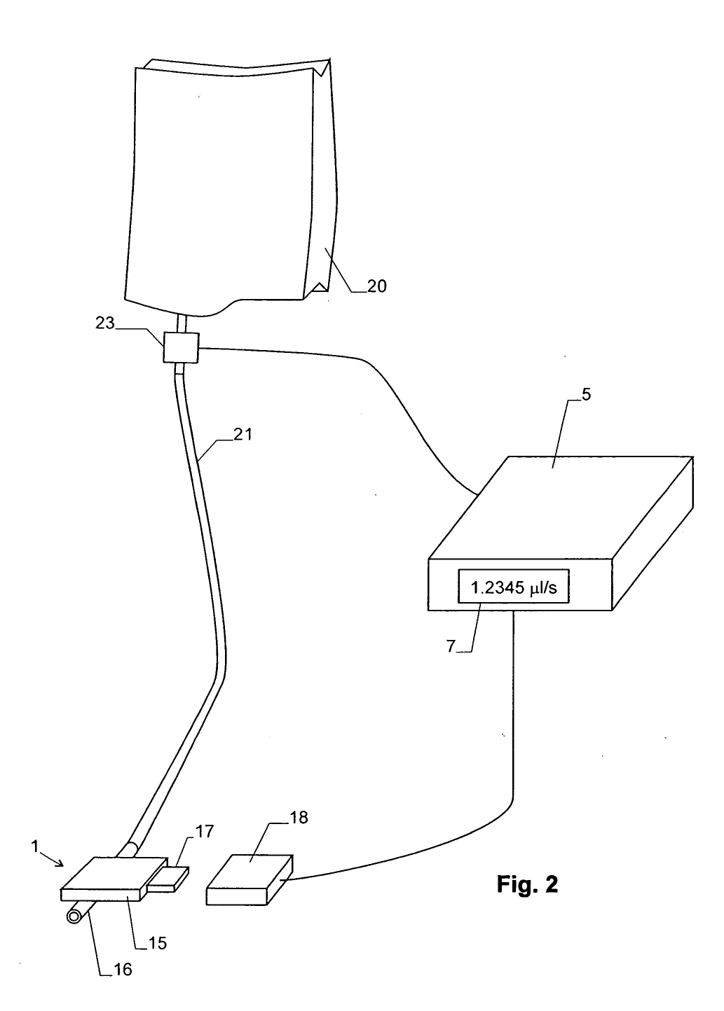

FIGS. 1 and 2 show some of the components of an embodiment of a device for measuring the flow of a fluid. The device comprises a flow sensor 1 integrated on a flow sensor chip la, in particular a semiconductor substrate. Flow sensor 1 is advantageously a thermal flow sensor comprising a heater 2 and at least one temperature sensor 3. A flow over the heater 2 changes the temperature and temperature distribution in the region around the heater, which, in turn, can be measured by the temperature sensor(s) 3 in order to generate a raw signal.

To keep costs low, heater 2 and temperature sensor(s) can be integrated components on a MEMS device.

An advantageous embodiment of such a device is described in DE 10129300. As shown in FIG. 10 of that document, it comprises a heater and two temperature sensors arranged on a substrate, advantageously a semiconductor substrate. The temperature sensors are thermopiles and are interconnected such that they measure a raw signal corresponding to the temperature difference before and after the heater.

Flow sensor 1 comprises electronic circuitry 4 integrated on sensor chip 1a, which includes:

Analogue circuitry 40 for the analogue processing (such as amplification and filtering) of the raw signal from the temperature sensors 3 as well as for driving heater 2.

An A/D converter 41 for converting the signal processed by the analogue circuitry 40.

A controller 42 for controlling operation of the flow sensor and for performing digital signal conditioning, such as linearization.

A digital interface 43 for data exchange with an external control unit (see below).

A digital memory 44 at least part of which non-volatile and rewritable. Interface 43 provides read/write access to at least part of memory 44.

When in use, a data connection between interface 43 of flow sensor 1 and an external control unit 5 is established. This data connection is capable of transferring digital data between flow sensor 1 and control unit 5, and it can e.g. be a direct electrical connection between flow sensor 1 and control unit 5 or a wireless connection. Advantageously, the data connection is bidirectional, allowing control unit 5 to also send data, such as commands, to sensor 1. Control unit 5 e.g. comprises a microprocessor system 6 with a memory 6a, a display 7 and an interface 8. Display 7 can, for example, be used to display the actual flow, e.g. in volumes/second or weight/second, as well as status information and messages. Interface 8 is used for interfacing with flow sensor 1.

Flow sensor 1 can also comprise further sensor elements, such as a temperature sensor for measuring the temperature of the fluid and/or of the substrate. Such additional sensors can be used to obtain more accurate flow results, as it is known to the skilled person.

As can be seen from FIG. 2, flow sensor 1 is e.g.

arranged in a housing 15, which may e.g. be directly cast around the substrate of the MEMS device mentioned above, or it may be a larger housing surrounding a protective housing cast about the MEMS device. Housing 15 can be connected to or can form a duct 16, in which the flow of the fluid is to be measured. Flow sensor 1 further comprises a connector 17 for detachably connecting it to control unit 5, e.g. by means of mating plug 18. Alternatively, a wireless interface between flow sensor 1 and control unit 5 can be provided.

The device of FIG. 2 further shows a fluid container 20, which e.g. contains a medical fluid. A tube 21 connects fluid container 20 and flow sensor 1. In FIG. 2, fluid container 20 is shown to be a bag, but it can e.g. also be a local gas bottle or a central gas reservoir.

The system further comprises a fluid pump or fluid valve, as schematically shown under reference number 23, used for conveying the fluid or controlling its flow in tube 21. Fluid pump or valve 23 can be controlled by control unit 5.

As it will be clear to the skilled person, fluid pump or valve 23 can be mounted at any suitable point along the fluid duct. It may be directly connected to container 20 and/or to flow sensor 1, or flow sensor 1 can be inserted into a suitable sensor section of fluid pump or valve 23. Also, fluid pump or valve 23 can be located in the same housing as control unit 5, or it can, as shown in FIG. 2, have its own housing. Similarly, flow sensor 1 can be (releasably) mounted to control unit 5, or the connection can be established through a cable as shown in FIG. 2.

### Operation

To measure a flow by means of flow sensor 1, sensor 1 is connected to control unit 5. Control unit 5 issues commands to flow sensor 1 and reads flow data through interfaces 8 and 43.

For sterilizing and/or cleaning flow sensor 1, flow sensor 1 is disconnected from control unit 5 and is placed, without control unit 5, in a sterilizing/cleaning apparatus, such as an autoclave, for thermal treatment.

Typically, during thermal treatment flow sensor 1 is subjected to temperatures exceeding 100° C., e.g. 120° C. for a period of e.g. several minutes or more.

After thermal treatment, flow sensor 1 is reconnected to control unit 5 for performing further flow measurements.

Alternatively to a thermal treatment, and/or in addition thereto, the sensor may also be subjected to a chemical treatment, in particular for sterilization purposes.

Before running a flow measurement, control unit 5 performs the following steps (not necessarily in the given order):

### Step 1: Preliminary Tests

Control unit 5 checks if it can operate with the connected flow sensor and if certain messages are to be shown. This can e.g. comprise at least one of the following checks:

Control unit 5 reads a type indicator that is stored in memory 44 of flow sensor 1. The type indicator indicates what properties and capabilities the flow sensor has. For example, the type indicator can be a part number attributed to the flow sensor by the manufacturer. It can e.g. be indicative of the commands and protocols the flow sensor is able to process, the flow range it is adapted for, its release version, etc. Based on the type indicator, control unit 5 can determine if it is able to communicate properly with a given flow sensor and if the flow sensor is able to carry out the required measurements. If not, an alert is issued.

Control unit 5 reads a number from memory 44 indicative of the counts of treatments the sensor has undergone. This number can e.g. be equal to the count of treatments, or it may e.g. be equal to the number of treatments that the sensor can still be subjected to before it becomes unreliable. This number is e.g. used to issue an alert if the sensor has already undergone a too large number of treatments, or it may e.g. be merely recorded for quality assurance and failure analysis purposes.

Control unit 5 reads an “expiry date” of flow sensor 1 from memory 1. This expiry date has been written into memory 44 e.g. by the manufacturer of the sensor and indicates a maximum age at which the flow sensor is guaranteed to operate correctly. Control unit 5 compares the expiry date with the current date (today) and issues an alert or rejects the flow sensor if the current date is after the expiry date.

Control unit 5 reads a “notification” stored in a notification storage of memory 44. This allows the manufacturer or distributor of the flow sensor to communicate with the end users. Depending on the notification, control unit 5 can e.g. initiate one of the following:

a) The notification can e.g. be defined to inform the user of control unit 5 of the availability of new software. For example, the notification can e.g. comprise the version number of the latest release of the software running in control unit 5 at the time the flow sensor was manufactured. If control unit 5 finds a notification indicating a version number greater than the version number of the software it is presently using, it can e.g. display a message indicative of a need to carry out a software update for the control unit 5. For example, the following message can be displayed on display 7: “Please update the software of this control unit to the latest version”.

b) The notification can e.g. be contain a message that the manufacturer of flow sensor 1 wants to display on display 7 of control unit 5, such as a security warning (e.g. “warning, this sensor is not graded for medical applications”) or an information message (e.g. “to order new flow sensors, please see www.flowsensors.biz”) or a news item (“New support phone number as from 01/01/09: 12345678”). Any such notification can include a conditional code, which specifies the criteria for displaying the message. For example, the notification may indicate a date range during which it is to be displayed or the type of control unit it should be displayed on.

### Step 2: Checking If A Sensor Test Is Required

Control unit 5 checks if a sensor test procedure has to be started. If yes, it continues with step 3 below.

The need for a sensor test can e.g. be derived based on one or both of the following criteria:

Control unit 5 checks if the flow sensor connected to it has been replaced since the last flow measurements. For this purpose, a unique serial number is stored in memory 44 of each flow sensor. Control unit 5 reads out this serial number and checks if it is equal to the serial number of the flow sensor used at a given port last time. If not, i.e. if the serial number has changed, this is a clear indicator that flow sensor 1 has been replaced and a sensor test procedure is started.

The user can indicate if a sensor test procedure is required, e.g. by manually operating an input control of control unit 5.

### Step 3: Increasing the Treatment Counter

If, during step 2, it has been determined that a test procedure is to be started, it is assumed that the sensor has been subjected to a treatment. In that case, control unit 5 causes the number in memory 44 to be updated. This can either be carried out (a) by issuing a command to flow sensor 1, which then updates the number by itself, or, advantageously, (b) by the control unit 5 reading out the number from memory 44, updating it, and writing it back to memory 44. Alternative (b) has the advantage that it allows to keep the circuitry in flow sensor 1 simpler.

The exact nature of how the number is “updated” depends on what the number stands for. If the number e.g. stands for the count of treatments the flow sensor has undergone, the number is updated by incrementing it by 1. If the number e.g. stands for the number of treatments that the sensor can still be subjected to before it becomes unreliable, the number is decremented by 1 if it is larger or equal to zero.

After updating the number, it should be checked using the criteria given in step 1 above.

In addition to updating the number, a time stamp indicative of the time (at least the date) of the update can be stored within memory 44. The updated time stamp can replace an existing time stamp of an earlier update, or it can be added to a list of time stamps stored as a log in memory 44.

### Step 4: Sensor Test Procedure

If, during step 2, it has been determined that a test procedure is to be started, at least one of the following sub-steps is initiated by control unit 5:

Flow sensor 1 is tested for integrity, i.e. for proper functioning. This can e.g. involve a self-test comprising one or more of the tests described in EP 1965179.

Operational parameters for flow sensor 1 are determined, such as an offset of the raw signal during zero flow, an amplification of an amplifier in analogue circuitry 40, a resistivity of heater 2, etc. These parameters are e.g. used for an at least partial recalibration of the sensor and/or they are stored in memory 44, e.g. for later reference during signal conditioning. If it is found that a parameter has changed by a large degree and/or falls outside an allowable range, a warning may be issued and/or the flow sensor can be rejected by control unit 5. In a particularly advantageous embodiment, a log of the operating parameters measured in several sensor test procedures is stored in memory 44, thereby describing the “history” of the sensor. This can e.g. be advantageous for quality control purposes or diagnosis, for example when trying to find out why a given flow sensor has failed. The log can also comprise the time stamps mentioned above.

### Step 5: Flow Measurements

During regular operation, control unit 5 operates flow sensor 1 to carry out flow measurements as mentioned above.

### Notes

As can be seen from the above, by storing appropriate information in the memory of flow sensor 1 the reliability of the system can be improved, a better quality control can be achieved, and new communication channels between manufacturer/distributor and end users become available.

The invention is particularly well suited for being used with disposable sensors, which are disposed after a certain time or a certain number of thermal processing cycles, but it can also be applied in other systems.

A primary field of application is in the area of drug delivery or in the field of measuring flow of body fluids through medical equipment.

While there are shown and described presently preferred embodiments of the invention, it is to be distinctly understood that the invention is not limited thereto but may be otherwise variously embodied and practised within the scope of the following claims.

1. A method for operating an flow sensor, wherein said flow sensor comprises a digital memory, said method comprising the steps of
repetitively subjecting said flow sensor to thermal and/or chemical treatment for sterilization and/or cleaning, and
storing a number indicative of a count of treatments that said flow sensor has been subjected to in non-volatile manner in said memory and updating said number after each treatment of said flow sensor.

2. The method of claim 1 wherein said flow sensor comprises a semiconductor substrate and wherein said memory is integrated in said flow sensor.

3. The method of claim 1 wherein said flow sensor comprises a heater and at least one temperature sensor, and in particular wherein said heater and said at least one temperature sensor are integrated on a semiconductor substrate (1a) of said flow sensor.

4. The method of claim 1 wherein, for measuring a flow, said flow sensor is connected to a control unit and, for said treatment, said flow sensor is disconnected from said control unit and thermally treated without said control unit.

5. The method of claim 4, wherein, after a treatment, said control unit causes said number to be updated.

6. The method of claim 4, wherein a unique serial number of said flow sensor is stored in said memory and wherein, when said control unit detects that the serial number of an attached flow sensor changes, it initiates a sensor test procedure and/or causes said number to be updated.

7. The method of claim 4 wherein said memory comprises a notification stored in a notification storage of said memory, and wherein said notification is read by said control unit and, wherein a message is issued by said control unit depending on said notification, and in particular wherein said message is indicative of a need to carry out a software update for said control unit.

8. The method of claim 4 wherein said memory comprises a notification stored in said notification storage, and wherein said notification comprises a message, which is displayed by said control unit.

9. The method of claim 4 wherein, for updating said number, said number is read from said memory by said control unit, updated in said control unit, and written back by said control unit into said memory.

10. The method of claim 1 wherein said flow sensor is repetitively subjected to sensor test procedures, wherein in each sensor test procedure, operating parameters of said flow sensor are measured, and, in particular, wherein said operating parameters are stored in said memory.

11. The method of claim 10 wherein a log of operating parameters measured in several sensor test procedures is stored in said memory.

12. The method of claim 1 wherein during said treatment said flow sensor is subjected to a temperature exceeding 100° C.

13. The method of claim 1 wherein said memory comprises an expiry date of said flow sensor.

14. The method of claim 4, wherein said memory comprises an expiry date of said flow sensor and wherein said method comprises the steps of
reading out said expiry date by said control unit
comparing said expiry date with a current date by said control unit and
issuing an alert and/or rejecting the flow sensor if the current date is after the expiry date.

15. The method of claim 1 wherein said flow sensor is repetitively subjected to sensor test procedures, wherein, during said sensor test procedures, said flow sensor is tested for integrity.

16. The method of claim 1 further comprising the step of storing a time stamp in said memory when updating said number.

17. A device for measuring a flow comprising a control unit and a flow sensor, wherein said flow sensor is detachably connectable to said control unit, wherein said flow sensor comprises a non-volatile memory for receiving a number indicative of a count of thermal and/or chemical treatments the flow sensor has been subjected to and wherein said control unit is structured and adapted to cause said number to be updated after a treatment.
